(19) United States
(12) Patent Application Publication
(10) Pub. No.: US 2024/0264322 A1
(43) Pub. Date: Aug. 8, 2024

(54) MULTI-PHASE WAVEFIELD INVERSION METHOD CONSIDERING BOTH BODY WAVES AND SURFACE WAVES IN HALF-SPACE OF ROCK MEDIA

(71) Applicant: DALIAN UNIVERSITY OF TECHNOLOGY, Dalian (CN)

(72) Inventors: Gang LI, Dalian (CN); Yaohui XUE, Dalian (CN); Zhiqian DONG, Dalian (CN); Dinghao YU, Dalian (CN); Hongnan LI, Dalian (CN)

(21) Appl. No.: 18/641,022

(22) Filed: Apr. 19, 2024

(30) Foreign Application Priority Data
Jun. 2, 2023 (CN) 202310647782.7

(51) Int. Cl. G01V 1/28; G01V 1/32

(52) U.S. Cl. CPC G01V 1/284; G01V 1/32

(57) ABSTRACT

The present invention provides a multi-phase wavefield inversion method considering both body waves and surface waves in half-space of rock media to address the deficiency in existing methods that neglect surface wavefields. In the present invention, Rayleigh components that strictly satisfy standard elliptic polarization characteristics in a half-space are extracted with Snell's Law of complex angles and the forward modeling and inversion theory of body waves. Then, the phase separation is executed to separate the body and Rayleigh waves. The pre-arrival components of S-waves are truncated to solve optimal incident angles of body waves. Thus, a Rayleigh wavefield inversion is implemented with ground Rayleigh components, and a body wavefield inversion is implemented with ground body components and their incident angles. Finally, based on linear elastic characteristics of the half-space of rock media, single-phase body wavefields and Rayleigh wavefields are superposed to form total multi-phase wavefields with the linear superposition principle.

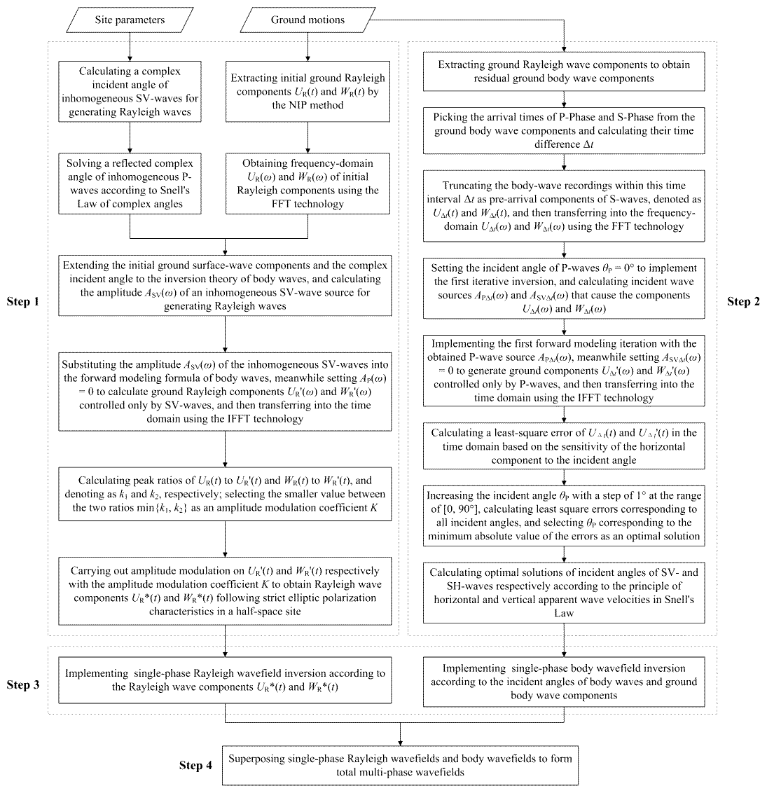

### TECHNICAL FIELD

The present invention relates to the field of seismic wavefield inversion, and relates to the multi-phase wavefield inversion method considering both body waves and surface waves in half-space of rock media.

### BACKGROUND

The seismic input of soil-structure interaction (SSI) systems needs to convert the underground free-field displacement, velocity, and stress into the equivalent earthquake loads on the artificial boundary. However, in earthquake engineering, strong-motion accelerographs or seismographs are generally placed on the ground surface and used to record ground motions. The lack of underground array records makes it difficult to acquire underground wavefields. Against this background, a seismic inversion method was born to invert the unknown underground wavefields based on the known ground motions and local site conditions.

The existing inversion methods consider whole ground motions as body wave components alone and only invert body wavefields, while neglecting the influence of surface waves. However, the records of ground motions are mixed waveforms composed of different phases, which contain rich surface (Rayleigh and Love) wave components besides body wave components. Surface waves exhibit wavefield characteristics significantly different from body waves: the energies of surface waves are concentrated within the range of one wavelength near the surface and decay rapidly with the increase of soil depth. Specifically, the trajectory of Rayleigh waves would change from the retrograde ellipse to the prograde ellipse as the soil depth increases. In addition, the amplitude of surface waves decays with the square root of the propagation distance, whereas the amplitude of body waves decays at the rate of the square of the propagation distance. The different decay rates lead to the gradual predominance of surface wave components in far-field ground motion records. Available studies have shown that the energy of surface waves accounts for about 67% of the total seismic waves, and the influence thereof cannot be ignored.

The unique characteristics of the half-space of rock media result in the surface wave components exclusively consisting of Rayleigh waves. Considering the multi-phase property of seismic waves, the development of a multi-phase wavefield inversion method is of great significance in improving the inversion accuracy and the seismic input of soil-structure interaction systems.

### SUMMARY

The present invention provides a multi-phase wavefield inversion method considering both body waves and surface waves in half-space of rock media to make up for the deficiency in existing inversion methods that neglect the surface wavefields.

The present invention has the following technical solution:

Based on Snell's Law of complex angles and the forward modeling and inversion theory of body waves, Rayleigh wave components that strictly satisfy standard elliptic polarization characteristics in a half-space are extracted. Next, the phase separation is executed to separate body waves and Rayleigh waves from the ground motions. Among others, the coupling P-SV body wave components are decoupled according to the propagation difference between P-waves and S-waves, and the pre-arrival components of S-waves are truncated as the motions controlled only by P-waves. The truncated pre-arrival components of S-waves are then applied to iteratively calculate the optimal incident angles of body waves. Based on this, a Rayleigh wavefield inversion is implemented with the extracted ground Rayleigh wave components, and a body wavefield inversion is implemented with the incident angles of body waves and ground body wave components. Finally, based on the linear elastic characteristics of the half-space of rock media, the single-phase body wavefields and the single-phase Rayleigh wavefields are superposed to form the total multi-phase wavefields with the linear superposition principle.

A multi-phase wavefield inversion method considering both body waves and surface waves in half-space of rock media, comprising the following steps:

Step 1: extending the forward modeling and inversion theory of body waves to Rayleigh waves based on the normalized inner product (NIP) method, and extracting Rayleigh wave components that satisfy standard elliptic polarization characteristics in half-space of rock media according to Snell's Law of complex angles, thereby inverting the surface wavefields, with the main process as follows:
1.1. Extracting an initial radial component U_{R}(t) and vertical component W_{R}(t) of Rayleigh waves using the NIP method, and transferring into frequency-domain U_{R}(ω) and W_{R}(ω) with the Fast Fourier Transform (FFT) technology to apply the body-wave inversion formula (1);

$$( \begin{matrix}{A}_{P} \\ {A}_{SV}\end{matrix} ) = {\frac{M}{{l}_{x} {m}_{x}} [ \begin{matrix}4 {l}_{x} st ( 1 + {s}^{2} ) ( 2 μ + λ ) & 2 {m}_{x} t ( 1 + {s}^{2} ) ( 1 - {t}^{2} ) ( 2 μ + λ ) \\ - 2 {l}_{x} s ( 1 + {t}^{2} ) ( λ + 2 μ {s}^{2} + λ {s}^{2} ) & - 4 μ {m}_{x} st ( 1 + {t}^{2} )\end{matrix} ]}^{- 1} ( \begin{matrix}{U}_{R} \\ {W}_{R}\end{matrix} ) \qquad ( 1 )$$

wherein A_{P} and A_{SV} are displacement amplitudes of incident P-waves and SV-waves, respectively; λ and μ are Lame constants of a half-space; lₓ and mₓ are sine values of incident angle θ_{P} of P-waves and incident angle θ_{SV} of SV-waves, respectively; s and t are cotangent values of θ_{P} and θ_{SV}, respectively; M is a parameter associated with the site parameters of the half-space and incident angles of θ_{P} and θ_{SV}.
1.2. Calculating an oblique incident complex angle φ_{SV} required for generating Rayleigh waves with inhomogeneous SV-waves as an incident wave source by the expression φ_{SV}=π/2+iarccosh(κ), wherein κ is a coefficient associated with the Poisson's ratio of the half-space and is greater than “1”.
1.3. Calculating a reflected complex angle φ_{P} of inhomogeneous P-waves caused by polarization exchange of incident inhomogeneous SV-waves according to Snell's Law of complex angles of formula (2),

$$\frac{sin {{θ}_{SV}}^{′} cosh {{θ}_{SV}}^{″} + i cos {{θ}_{SV}}^{′} sinh {{θ}_{SV}}^{″}}{{V}_{SV}} = \frac{sin {{θ}_{P}}^{′} cosh {{θ}_{P}}^{″} + i cos {{θ}_{P}}^{′} sinh {{θ}_{P}}^{″}}{{V}_{P}} \qquad ( 2 )$$

wherein φ_{P}′ and φ_{SV}′ are the real part of the reflected complex angle φ_{P} of inhomogeneous P-waves and the incident complex angle φ_{SV} of inhomogeneous SV-waves, respectively; φ_{P}″ and φ_{SV}″ are the imaginary part of the reflected complex angle φ_{P} of inhomogeneous P-waves and the incident complex angle φ_{SV} of inhomogeneous SV-waves, respectively; V_{SV} and V_{P} are propagation velocities of SV-waves and P-waves in the half-space of rock media, respectively.
1.4. Calculating parameters of lₓ, mₓ, s, t, and M that relate to the incident complex angle φ_{SV} and the reflected complex angle φ_{P}, and implementing an inversion algorithm to calculate excitation wave sources A_{P}(ω) and A_{SV}(ω).
1.5. Implementing a forward modeling algorithm to eliminate the perturbations of P-waves to Rayleigh waves: substituting the inverted A_{SV}(ω) and the incident complex angle φ_{SV} into body-wave forward modeling formula (3), meanwhile setting A_{P}(ω)=0 to calculate ground Rayleigh components U_{R}′(ω) and W_{R}′(ω) controlled only by SV-waves.

$$( \begin{matrix}{{U}_{R}}^{′} \\ {{W}_{R}}^{′}\end{matrix} ) = \frac{{l}_{x} {m}_{x}}{M} [ \begin{matrix}4 {l}_{x} st ( 1 + {s}^{2} ) ( 2 μ + λ ) & 2 {m}_{x} t ( 1 + {s}^{2} ) ( 1 - {t}^{2} ) ( 2 μ + λ ) \\ - 2 {l}_{x} s ( 1 + {t}^{2} ) ( λ + 2 μ {s}^{2} + λ {s}^{2} ) & - 4 μ {m}_{x} st ( 1 + {t}^{2} )\end{matrix} ] ( \begin{matrix}{A}_{P} \\ {A}_{SV}\end{matrix} ) \qquad ( 3 )$$

1.6. Transferring frequency-domain components U_{R}′(ω) and W_{R}′(ω) of ground Rayleigh waves obtained with the above forward modeling process into the time-domains U_{R}′(t) and W_{R}′(t) using the Inverse Fast Fourier Transform (IFFT) technology, where U_{R}′(t) and W_{R}′(t) maintain in the same phase as the initial Rayleigh components U_{R}(t) and W_{R}(t) and carry the same spectral characteristics as the original waveforms to the greatest extent.
1.7. calculating peak ratios of U_{R}(t) to U_{R}′(t) and W_{R}(t) to W_{R}′(t), and denoting as k₁ and k₂, respectively; selecting the smaller value between the two ratios min{k₁, k₂} as a final amplitude modulation coefficient K; and multiplying U_{R}′(t) and W_{R}′(t) by the modulation coefficient K respectively to obtain U_{R}*(t) and W_{R}*(t) for the same amplitudes, where the modified U_{R}*(t) and W_{R}*(t) are exactly Rayleigh wave components following strict elliptic polarization characteristics in the half-space.

Step 2: based on the difference between propagation velocities of P-waves and S-waves, iterating ground body-wave components before S-wave arrival with the forward modeling and inversion theory, and then determining an optimal oblique incident angle of P-waves with the least-square target function, thereby inverting the body wavefields, with the specific process as follows:
2.1. Determining the arrival times of P-Phase and S-Phase from the ground motions using the P/S-Phase arrival-time picker, respectively; calculating their time difference Δt and truncating the body-wave recordings within this time interval as pre-arrival components of S-waves, denoted as U_{Δt}(t) and W_{Δt}(t) controlled only by incident wave source P-waves theoretically and independent of SV waves.
2.2. Setting the incident angle of P-waves θ_{P}=0° to implement the first iterative inversion: substituting parameter lₓ, mₓ, s, t, and M related to the angle θ_{P} into the body-wave inversion formula (1), and calculating incident wave sources A_{pΔt}(ω) and A_{svΔt}(ω) that cause the pre-arrival components of S-waves.
2.3. Implementing the first forward modeling iteration with obtained wave source A_{pΔt}(ω) to calculate the ground displacements U_{Δt}′(ω) and W_{Δt}′(ω) controlled by P-waves alone, meanwhile setting A_{svΔt}(ω)=0 to eliminate the perturbations of S-waves.
2.4. Calculating the least-square error of U_{Δt}(t) and U_{Δt}′(t) in the time domain with formula (4) based on the sensitivity of the horizontal component to the incident angle θ_{P}, the optimal solution of which corresponds to the minimum least-square error in theory,

$$e = \frac{1}{N} \sqrt{{\sum }_{n = 1}^{N} {[ {U}_{Δ t} ( t ) - {{U}_{Δ t}}^{′} ( t ) ]}^{2}} \qquad ( 4 )$$

wherein n is the discrete point of time-domain records U_{Δt}(t) and U_{Δt}′(t), and Nis the total number of discrete points.
2.5. Increasing the incident angle θ_{P} with a step of 1° within the range of 0-90° to repeat steps 2.2, 2.3, and 2.4, and exporting least-square errors corresponding to all incident angles within the iteration range.
2.6. Selecting θ_{P} corresponding to the minimum absolute value of least-square error and defining it as an optimal oblique incident angle of P-waves.
2.7. Calculating an optimal solution of the incident angle of SV-waves based on the principle of equal horizontal apparent wave velocities in Snell's Law, and calculating an optimal solution of the incident angle of SH-waves based on the principle of equal vertical apparent wave velocities.

Step 3: implementing the respective single-phase wavefield inversion for body waves and Rayleigh waves, respectively.

Step 4: based on approximate linear elastic characteristics of the half-space of rock media, superimposing single-phase body wavefields and single-phase Rayleigh wavefields to form the total multi-phase wavefields through the linear superposition principle.

The present invention has the following beneficial effects:

(1) The present invention provides a multi-phase wavefield inversion method considering both body waves and surface waves in half-space of rock media, which fully considers the multi-phase property of seismic waves and makes up for the deficiency in existing inversion methods that neglect the surface wavefields. The inverted displacement results are in good agreement with the real underground borehole records both in phases and amplitudes, thereby improving the inversion accuracy of free fields. The method of the present invention provides more accurate seismic input for analysis of soil-structure interaction systems, and has significant engineering application for revealing the real seismic response behaviors, damage mechanisms, and failure modes of structures.

(2) The method of the present invention extracts Rayleigh wave components that satisfy standard elliptic polarization properties in the half-space by adopting the forward modeling and inversion theory of body waves and Snell's Law of complex angles, and solves the problems that the propagation and the polarization direction are inconsistent in the trajectory of Rayleigh waves caused by the NIP method, which cannot be directly used for inversion calculation.

The body-wave phase and the surface-wave phase in ground motions are mixed from each other, and the separation of the two phases is an important technical difficulty in multi-phase wavefield inversion. In particular, the rationality and accuracy of Rayleigh wave components play a direct role in the inversion results of surface wavefields. In the NIP method, the Rayleigh waves are extracted with the constraint condition where NIP between the horizontal component and shifted vertical component with phase advanced by π/2 exceeds 0.7 is met, which leads to that the phase difference between the two components is not strictly pi/2 and violates the consistent characteristic between the polarization and propagation direction. In addition, Rayleigh wave components extracted by the NIP method result in the nonzero shear stress at the ground surface, which contradicts the initial boundary stress conditions for inversion, and thus it is difficult to invert surface wavefields. Based on the NIP method, the method of the present invention extracts Rayleigh wave components that satisfy both the standard elliptic polarization properties of the half-space and the initial boundary stress conditions for inversion. The processes of formula derivation are simple, and the calculation results are efficient.

(3) The method of the present invention decouples the coupling motions of P-SV body waves according to the difference between propagation velocities of P-waves and S-waves, and uses the P-wave components before S-wave arrival to solve the technical problem of determining the optimal incident angles of body waves.

After the body wave components are determined, the incident angles of body waves become the unique variables in the body-wave inversion process. Any pair of incident angle solutions can make the inversion tenable, which is a one-to-many mapping problem. The incident angles have a significant influence on the inversion results. In the case of the stress results, for example, the larger the incident angles, the larger the stress values. Therefore, the key step in body-wave inversion is to find the optimal incident angles of incident waves. The method of the present invention constructs a least-square target function by the difference between the propagation velocities of P-waves and S-waves, and determines the optimal solution of the incident angle of P-waves by iteration. The process has a clear physical meaning, sufficient theoretical basis, and low iterative calculation cost.

### DESCRIPTION OF DRAWINGS

The sole figure is a flow chart of a method of the present invention.

### DETAILED DESCRIPTION

The present invention will be further described below in combination with the drawings in the embodiment of the present invention.

In step 1 of the sole figure, the ground Rayleigh wave components are extracted according to the site parameters and ground motions, and the body wave components required in step 2 are also determined according to the phase separation. Rayleigh waves are a kind of inhomogeneous waves generated by the superposition of inhomogeneous P-waves and inhomogeneous SV-waves at the ground surface interface of the P-SV plane. Unlike homogeneous body waves generated by real oblique incident angles, inhomogeneous waves are formed at an incident complex angle φ=φ′+iφ″, and the complex angle has no actual physical meaning. The oblique incidence of complex angle would lead to their sine values being also complex, expressed as sin φ=sin φ′ cos hφ″+i cos φ′ sin h φ″, wherein the real part characterizes the phases of inhomogeneous waves, and the imaginary part characterizes the amplitudes of inhomogeneous waves. An equiphase plane and an equiamplitude plane are orthogonal to each other, and the amplitudes exhibit the exponential decay associated with Rayleigh waves. Based on the generation principle of inhomogeneous waves, it can be considered that Rayleigh waves are superimposed by incident inhomogeneous SV-waves with a complex angle and reflected inhomogeneous P-waves at the ground surface. The inhomogeneous incident SV-waves here are assumed as the simulated excitation source of Rayleigh waves. The oblique incident SV-waves with the complex angle result in polarization exchange at the ground surface, generating reflected inhomogeneous SV-waves and P-waves, and the reflected angles are expressed as follows:

$$\{ \begin{matrix}sin {φ}_{SV} = sin {{φ}_{SV}}^{′} cosh {{φ}_{SV}}^{″} + i cos {{φ}_{SV}}^{′} sinh {{φ}_{SV}}^{″} \\ sin {φ}_{P} = sin {{φ}_{P}}^{′} cosh {{φ}_{P}}^{″} + i cos {{φ}_{P}}^{′} sinh {{φ}_{P}}^{″}\end{matrix} \qquad ( 5 )$$

wherein φ_{P}′ and φ_{SV}′ represent real parts of the reflected complex angle of P-wave and SV-waves, φ_{P}″ and φ_{SV}″ represent corresponding imaginary parts, and i is the imaginary unit. It has been proved by the existing studies that Snell's Law is also applicable to complex angles, as shown in formula (2). The reflection coefficients R_{SP} and R_{SS} of the reflected inhomogeneous SV-waves and P-waves can be calculated according to the Zoeppritz equation in formula (6):

$$\{ \begin{matrix}{R}_{SS} = \frac{{V}_{SV}^{2} sin ( 2 {φ}_{SV} ) sin ( 2 {φ}_{P} ) - {V}_{P}^{2} {cos}^{2} ( 2 {φ}_{SV} )}{{V}_{SV}^{2} sin ( 2 {φ}_{SV} ) sin ( 2 {φ}_{P} ) + {V}_{P}^{2} {cos}^{2} ( 2 {φ}_{SV} )} \\ {R}_{SP} = \frac{2 {V}_{P} {V}_{SV} sin ( 2 {φ}_{SV} ) cos ( 2 {φ}_{SV} )}{{V}_{SV}^{2} sin ( 2 {φ}_{SV} ) sin ( 2 {φ}_{P} ) + {V}_{P}^{2} {cos}^{2} ( 2 {φ}_{SV} )}\end{matrix} \qquad ( 6 )$$

wherein the reflection coefficient R_{SS} has a special case, i.e., the numerator is 0, that is:

$$\frac{{cos}^{2} ( 2 {φ}_{SV} )}{{V}_{SV}^{2}} = \frac{sin ( 2 {φ}_{SV} ) sin ( 2 {φ}_{P} )}{{V}_{P}^{2}} \qquad ( 7 )$$

It means that reflected inhomogeneous SV-waves are not generated and only incident inhomogeneous SV-waves and reflected inhomogeneous P-waves are present in the half-space, which is consistent with the mechanism of generating Rayleigh waves. By combining formulas (2) and (7), the complex solution of incident angle φ_{SV} of inhomogeneous SV-waves can be calculated; and the solution exactly corresponds to the incident angle for generating Rayleigh waves in the half-space, satisfying:

$${φ}_{SV} = \frac{π}{2} + i arc cosh ( κ ) \qquad ( 8 )$$

Due to the applicability of Snell's Law to complex angles, the forward modeling and inversion theory of body waves can also be applied to Rayleigh waves. Forward modeling and inversion of body waves in the P-SV plane are shown in formulas (9) and (10), respectively:

$$( \begin{matrix}{U}_{B} \\ {W}_{B}\end{matrix} ) = \frac{{l}_{x} {m}_{x}}{M} [ \begin{matrix}4 {l}_{x} st ( 1 + {s}^{2} ) ( 2 μ + λ ) & 2 {m}_{x} t ( 1 + {s}^{2} ) ( 1 - {t}^{2} ) ( 2 μ + λ ) \\ - 2 {l}_{x} s ( 1 + {t}^{2} ) ( λ + 2 μ {s}^{2} + λ {s}^{2} ) & - 4 μ {m}_{x} st ( 1 + {t}^{2} )\end{matrix} ] ( \begin{matrix}{A}_{P} \\ {A}_{SV}\end{matrix} ) \qquad ( 9 )$$

$$( \begin{matrix}{A}_{P} \\ {A}_{SV}\end{matrix} ) = {\frac{M}{{l}_{x} {m}_{x}} [ \begin{matrix}4 {l}_{x} st ( 1 + {s}^{2} ) ( 2 μ + λ ) & 2 {m}_{x} t ( 1 + {s}^{2} ) ( 1 - {t}^{2} ) ( 2 μ + λ ) \\ - 2 {l}_{x} s ( 1 + {t}^{2} ) ( λ + 2 μ {s}^{2} + λ {s}^{2} ) & - 4 μ {m}_{x} st ( 1 + {t}^{2} )\end{matrix} ]}^{- 1} ( \begin{matrix}{U}_{B} \\ {W}_{B}\end{matrix} ) \qquad ( 10 )$$

The main process for extracting Rayleigh components that satisfy standard elliptical polarization properties through the forward modeling and inversion theory of body waves is as follows:
i. Transferring the time-domain radial component U_{R}(t) and vertical component W_{R}(t) of the initial Rayleigh surface waves extracted by the NIP method into the frequency-domains U_{R}(ω) and W_{R}(ω) by the FFT technology;
ii. Substituting U_{R}(ω) and W_{R}(ω) into formula (10) to replace U_{B}(ω) and W_{B}(ω), and substituting the incident complex angle shown in formula (8) to calculate simulated excitation sources A_{P}(ω) and A_{SV}(ω) of Rayleigh waves;
iii. The incident complex angle is derived from the simulated source of SV-waves, and hence should meet the condition A_{P}(ω)=0 in theory. However, since the Rayleigh wave components extracted by the NIP method do not satisfy the standard elliptic polarization, nonzero P-waves would be inevitably generated through the above inversion process. To eliminate the perturbations of P-waves to Rayleigh waves, A_{SV}(ω) obtained by inversion and the incident complex angle are substituted into the forward modeling formula (9), meanwhile A_{P}(ω)=0 is set to calculate new ground Rayleigh components U_{R}′(ω) and W_{R}′(ω) controlled only by SV-waves;
iv. Transferring the new Rayleigh components into time-domains U_{R}′(t) and W_{R}′(t) by the IFFT technology. Among others, U_{R}′(t) and W_{R}′(t) maintain in the same phase as the initial Rayleigh components U_{R}(t) and W_{R}(t);
v. The newly generated Rayleigh waves carry the same spectral components as the original waveforms to the greatest extent, but with a significant difference in amplitudes. To maintain same amplitudes, the peak ratios of U_{R}(t) to U_{R}′(t) and W_{R}(t) to W_{R}′(t) are calculated respectively and denoted as k₁ and k₂; and then the smaller value of the two ratios min{k₁, k₂} is selected as a final amplitude modulation coefficient K;
vi. Amplitude modulating U_{R}′(t) and W_{R}′(t) with the coefficient K, respectively. The modified U_{R}*(t) and W_{R}*(t) after amplitude modulation are exactly Rayleigh wave records following strict elliptic polarization properties in the half-space, and used to invert surface wavefields in step 3 of the sole figure.

In step 2 of the figure, the optimal incident angles of body waves are determined according to the body wave components. In the inversion of body waves, the determination of parameters lₓ, mₓ, s, and t relies on incident angles θ_{P}, θ_{SV}, and θ_{SH} of oblique incident P-, SV- and SH-waves. Any pair of incident angle solutions can make the inversion equation tenable, which is a one-to-many mapping problem, so the key step in body-wave inversion is to find the optimal incident angles of incident waves. According to the difference between propagation velocities of P- and S-waves, the present invention proposes a method for solving the optimal solution of the incident angle of P-waves based on the least-square error, and then solves the optimal solutions of incident angles of SV- and SH-waves with Snell's Law. Since the P-waves propagate faster than S-waves in media, the motions before S-wave arrival can be regarded to be generated by P-waves independently. In this case, the coupling action of P-wave incidence and S-wave incidence can be decoupled into only P-wave action, thus the incident angle of P-waves can be iteratively determined by the motions before S-wave arrival using forward modeling and inversion theory. The basic idea is as follows: iterating successively the incident angle of the P-waves within the incident range [0°, 90°] into the inversion formula (10) to invert incident P- and SV-wave sources based on the motions before S-wave arrival. Among others, the P-wave source contains all the information about the pre-arrival motions of S-waves. The obtained P-wave source with the inversion process is applied to the forward modeling process of formula (9) to generate the new ground motions corresponding to every incident angle. In this case, it should be noted that no SV-waves are involved, that is, A_{SV} in the formula is set to be zero. In theory, the original motions before S-wave arrival are expected to bear the closest resemblance to the new ground motions completely controlled by P-waves under the condition of the optimal incident angle. Therefore, the least-square error of the two is calculated, and the incident angle corresponding to the minimum least-square error within the iteration range is defined as the optimal solution of the incident angle of P-waves. Then, the incident angle of S-waves is determined according to the principle of equal horizontal and vertical apparent wave velocities in Snell's Law. Specific operation steps are as follows:
i. Determining the arrival times of P- and S-waves using the P/S-Phase arrival-time picker, respectively, and calculating the time difference Δt;
ii. Separating body waves from surface waves and truncating body-wave motions within the time interval Δt as pre-arrival records of S-waves, denoted as U_{Δt}(t) and W_{Δt}(t), and then obtaining frequency-domains U_{Δt}(ω) and W_{Δt}(ω) by the FFT technology;
iii. Substituting the pre-arrival records of S-waves U_{Δt}(ω) and W_{Δt}(ω) into formula (10) for first inversion with θ_{P}=0°, and then substituting the inverted A_{pΔt}(ω) into forward modeling formula (9) to obtain ground displacements U_{Δt}′(ω) and W_{Δt}′(ω) under the action of the P-waves alone by setting A_{svΔt}(ω)=0 and soil depth z=0.
iv. Repeating the above steps by increasing θ_{P} with a step of 1° at the range of less than the critical angle 90° until the original records U_{Δt}(t) and U_{Δt}′(t) have a minimum least-square error, and exporting the corresponding Br as the optimal solution of the incident angle of P-waves, wherein the least-square error is calculated according to formula (4).
v. Calculating an optimal solution of the incident angle of SV-waves by formula (11) according to the principle of equal horizontal apparent wave velocities in Snell's Law, and calculating an optimal solution of the incident angle of SH-waves by formula (12) according to the principle of equal vertical apparent wave velocities.

$$\frac{sin {θ}_{SV}}{{V}_{S}} = \frac{sin {θ}_{P}}{{V}_{P}} \qquad ( 11 )$$

$$\frac{cos {θ}_{SH}}{{V}_{S}} = \frac{cos {θ}_{P}}{{V}_{P}} \qquad ( 12 )$$

In step 3 of the sole figure, single-phase surface wavefields are constructed according to the ground Rayleigh components, and single-phase body wavefields are constructed according to the ground body components and incident angle of body waves. Due to the large stiffness, large elasticity modulus, and small nonlinear deformation, the half-space of rock media possesses approximate linear elastic characteristics and holds the linear superposition principle. Based on this, in step 4 of the sole figure, the single-phase body wavefields and the surface wavefields are superposed to form the total multi-phase wavefields.

1. A multi-phase wavefield inversion method considering both body waves and surface waves in half-space of rock media, comprising the following steps:
step 1: extending the forward modeling and inversion theory of body waves to Rayleigh waves based on the normalized inner product (NIP) method, and extracting Rayleigh wave components that satisfy standard elliptic polarization characteristics in half-space of rock media according to Snell's Law of complex angles, thereby inverting the surface wavefields;
the specific process of step 1 is as follows:
2.8. extracting an initial radial component U_{R}(t) and vertical component W_{R}(t) of Rayleigh waves using the NIP method, and transferring into frequency-domain U_{R}(ω) and W_{R}(ω) with the Fast Fourier Transform (FFT) technology to apply the body-wave inversion formula (1);
$$( \begin{matrix}{A}_{P} \\ {A}_{SV}\end{matrix} ) = {\frac{M}{{l}_{x} {m}_{x}} [ \begin{matrix}4 {l}_{x} st ( 1 + {s}^{2} ) ( 2 μ + λ ) & 2 {m}_{x} t ( 1 + {s}^{2} ) ( 1 - {t}^{2} ) ( 2 μ + λ ) \\ - 2 {l}_{x} s ( 1 + {t}^{2} ) ( λ + 2 μ {s}^{2} + λ {s}^{2} ) & - 4 μ {m}_{x} st ( 1 + {t}^{2} )\end{matrix} ]}^{- 1} ( \begin{matrix}{U}_{R} \\ {W}_{R}\end{matrix} ) \qquad ( 1 )$$
wherein A_{P} and A_{SV} are displacement amplitudes of incident P-waves and SV-waves, respectively; λ and μ are Lame constants of a half-space; lₓ and mₓ are sine values of incident angle θ_{P} of P-waves and incident angle θ_{SV} of SV-waves, respectively; s and t are cotangent values of θ_{P} and θ_{SV}, respectively; M is a parameter associated with the site parameters of the half-space and incident angles of θ_{P} and θ_{SV};
2.9. calculating an oblique incident complex angle φ_{SV} required for generating Rayleigh waves with inhomogeneous SV-waves as an incident wave source by the expression φ_{SV}=π/2+iarccosh(κ), wherein κ is a coefficient associated with the Poisson's ratio of the half-space and is greater than “1”;
2.10. calculating a reflected complex angle φ_{P} of inhomogeneous P-waves caused by polarization exchange of incident inhomogeneous SV-waves according to Snell's Law of complex angles of formula (2),
$$\frac{sin {{φ}_{SV}}^{′} cosh {{φ}_{SV}}^{″} + i cos {{φ}_{SV}}^{′} sinh {{φ}_{SV}}^{″}}{{V}_{SV}} = \frac{sin {{φ}_{P}}^{′} cosh {{φ}_{P}}^{″} + i cos {{φ}_{P}}^{′} sinh {{φ}_{P}}^{″}}{{V}_{P}} \qquad ( 2 )$$
wherein φ_{P}′ and φ_{SV}′ are the real part of the reflected complex angle op of inhomogeneous P-waves and the incident complex angle φ_{SV} of inhomogeneous SV-waves, respectively; φ_{P}″ and φ_{SV}″ are the imaginary part of the reflected complex angle φ_{P} of inhomogeneous P-waves and the incident complex angle φ_{SV} of inhomogeneous SV-waves, respectively; V_{SV} and V_{P} are propagation velocities of SV-waves and P-waves in the half-space of rock media, respectively;
2.11. calculating parameters of lₓ, mₓ, s, t, and M that relate to the incident complex angle φ_{SV} and the reflected complex angle φ_{P}, and implementing an inversion algorithm to calculate excitation wave sources A_{P}(ω) and A_{SV}(ω);
2.12. implementing a forward modeling algorithm to eliminate the perturbations of P-waves to Rayleigh waves: substituting the inverted A_{SV}(ω) and the incident complex angle φ_{SV} into body-wave forward modeling formula (3), meanwhile setting A_{P}(ω)=0 to calculate ground Rayleigh components U_{R}′(ω) and W_{R}′(ω) controlled only by SV-waves;
$$( \begin{matrix}{{U}_{R}}^{′} \\ {{W}_{R}}^{′}\end{matrix} ) = \frac{{l}_{x} {m}_{x}}{M} [ \begin{matrix}4 {l}_{x} st ( 1 + {s}^{2} ) ( 2 μ + λ ) & 2 {m}_{x} t ( 1 + {s}^{2} ) ( 1 - {t}^{2} ) ( 2 μ + λ ) \\ - 2 {l}_{x} s ( 1 + {t}^{2} ) ( λ + 2 μ {s}^{2} + λ {s}^{2} ) & - 4 μ {m}_{x} st ( 1 + {t}^{2} )\end{matrix} ] ( \begin{matrix}{A}_{P} \\ {A}_{SV}\end{matrix} ) \qquad ( 3 )$$
2.13. transferring frequency-domain components U_{R}′(ω) and W_{R}′(ω) of ground Rayleigh waves obtained with the above forward modeling process into the time-domains U_{R}′(t) and W_{R}′(t) using the Inverse Fast Fourier Transform (IFFT) technology, where U_{R}′(t) and W_{R}′(t) maintain in the same phase as the initial Rayleigh components U_{R}(t) and W_{R}(t) and carry the same spectral characteristics as the original waveforms to the greatest extent;
2.14. calculating peak ratios of U_{R}(t) to U_{R}′(t) and W_{R}(t) to W_{R}′(t), and denoting as k₁ and k₂, respectively; selecting the smaller value between the two ratios min{k₁, k₂} as a final amplitude modulation coefficient K; and multiplying U_{R}′(t) and W_{R}′(t) by the modulation coefficient K respectively to obtain U_{R}*(t) and W_{R}*(t) for the same amplitudes, where the modified U_{R}*(t) and W_{R}*(t) are exactly Rayleigh wave components following strict elliptic polarization characteristics in the half-space;
step 2: based on the difference between propagation velocities of P-waves and S-waves, iterating ground body-wave components before S-wave arrival with the forward modeling and inversion theory, and then determining an optimal oblique incident angle of P-waves with the least-square target function, thereby inverting the body wavefields;
the specific process of step 2 is as follows:
2.1. determining the arrival times of P-Phase and S-Phase from the ground motions using the P/S-Phase arrival-time picker, respectively; calculating their time difference Δt and truncating the body-wave recordings within this time interval as pre-arrival components of S-waves, denoted as U_{Δt}(t) and W_{Δt}(t) controlled only by incident wave source P-waves theoretically and independent of SV-waves;
2.2. setting the incident angle of P-waves θ_{P}=0° to implement the first iterative inversion: substituting parameter lₓ, mₓ, s, t, and M related to the angle θ_{P} into the body-wave inversion formula (1), and calculating incident wave sources A_{pΔt}(ω) and A_{svΔt}(ω) that cause the pre-arrival components of S-waves;
2.3. implementing the first forward modeling iteration with obtained wave source A_{pΔt}(ω) to calculate the ground displacements U_{Δt}′(ω) and W_{Δt}′(ω) controlled by P-waves alone, meanwhile setting A_{svΔt}(ω)=0 to eliminate the perturbations of S-waves;
2.4. calculating the least-square error of U_{Δt}(t) and U_{Δt}′(t) in the time domain with formula (4) based on the sensitivity of the horizontal component to the incident angle θ_{P}, the optimal solution of which corresponds to the minimum least-square error in theory;
$$e = \frac{1}{N} \sqrt{{\sum }_{n = 1}^{N} {[ {U}_{Δ t} ( t ) - {{U}_{Δ t}}^{′} ( t ) ]}^{2}} \qquad ( 4 )$$
wherein n is the discrete point of time-domain records U_{Δt}(t) and U_{Δt}′(t), and Nis the total number of discrete points;
2.5. increasing the incident angle θ_{P} with a step of 1° within the range of 0-90° to repeat steps 2.2, 2.3 and 2.4, and exporting least-square errors corresponding to all incident angles within the iteration range;
2.6. selecting θ_{P} corresponding to the minimum absolute value of least-square error and defining as an optimal oblique incident angle of P-waves;
2.7. calculating an optimal solution of the incident angle of SV-waves based on the principle of equal horizontal apparent wave velocities in Snell's Law, and calculating an optimal solution of the incident angle of SH-waves based on the principle of equal vertical apparent wave velocities;
step 3: implementing the respective single-phase wavefield inversion for body waves and Rayleigh waves, respectively;
step 4: based on approximate linear elastic characteristics of the half-space of rock media, superimposing single-phase body wavefields and single-phase Rayleigh wavefields to form the total multi-phase wavefields through the linear superposition principle.
